(19) United States
(12) Patent Application Publication
(10) Pub. No.: US 2015/0019764 A1
(43) Pub. Date: Jan. 15, 2015

(54) INFORMATION DISPLAYING METHOD, MOBILE TERMINAL DEVICE AND NON-TRANSITORY COMPUTER READABLE STORAGE MEDIUM

(71) Applicant: TENCENT TECHNOLOGY (SHENZHEN) COMPANY LIMITED, Guangdong (CN)

(72) Inventor: Junke ZHANG, Guangdong (CN)

(21) Appl. No.: 14/498,882

(22) Filed: Sep. 26, 2014

Related U.S. Application Data
(63) Continuation of application No. PCT/CN2013/072183, filed on Mar. 5, 2013.

(30) Foreign Application Priority Data
Apr. 1, 2012 (CN) 201210094494.5

(51) Int. Cl. G06F 11/30

(52) U.S. Cl. CPC G06F 11/3065
USPC 710/19

(57) ABSTRACT

Examples of the present disclosure may provide an information displaying method, mobile terminal device and non-transitory computer readable storage medium. The method may include: monitoring an execution status of an application on a mobile terminal device, obtaining memory information of the mobile terminal device when a monitoring result shows that the application is executed and displaying the memory information of the mobile terminal device on the mobile terminal device.

This application is a continuation of International Application No. PCT/CN2013/072183, filed on Mar. 5, 2013, which claims priority to Chinese patent application No. 201210094494.5, filed on Apr. 1, 2012, the content of which are incorporated herein by reference in their entirety.

### FIELD OF THE INVENTION

The present disclosure relates to a field of communication technology, and more particularly, to an information displaying method, mobile terminal device and non-transitory computer readable storage medium.

### BACKGROUND

With the population of the mobile terminal device, such as a mobile phone or a handheld device, a user may put forward more and more requirements on the mobile terminal device. For instance, in order to conveniently manage the memory of the mobile terminal device, the user may wish to conveniently obtain memory footprint of the mobile terminal device. If too much memory is occupied, the user may clear up the memory in time, which is convenient for the management of the terminal device.

### SUMMARY

An example of the present disclosure may provide an information displaying method, mobile terminal device and a non-transitory computer readable storage medium.

An information displaying method includes:
monitoring an execution status of an application on a mobile terminal device;
obtaining memory information of the mobile terminal device when a monitoring result shows that the application is executed; and
displaying the memory information of the mobile terminal device on the mobile terminal device.

A mobile terminal device includes:
a memory, to store a monitoring instruction, an obtaining instruction and a displaying instruction; and
a processor, to
execute the monitoring instruction to monitor an execution status of an application on the mobile terminal device;
execute the obtaining instruction to obtain memory information of the mobile terminal device when a monitoring result shows that the application is executed; and
execute the displaying instruction to display the memory information of the mobile terminal device on the mobile terminal device.

A non-transitory computer readable storage medium includes one or more than one program, to
monitor an execution status of an application on a mobile terminal device;
obtain memory information of the mobile terminal device when a monitoring result shows that the application is executed; and
display the memory information of the mobile terminal device on the mobile terminal device.

The mobile terminal device may monitor an execution status of an application on the mobile terminal device. When the monitoring result shows that the application is executed, the memory information of the mobile terminal device may be obtained. The mobile terminal device may display the memory information of the mobile terminal device. Therefore, when the application is executed, the memory information of the mobile terminal device may be obtained and displayed. The user may not need to search for the memory information via opening multiple folders. The memory footprint of the mobile terminal device may be intuitively obtained. The operation time may be reduced and memory footprint searching efficiency may be enhanced.

### BRIEF DESCRIPTION OF THE DRAWINGS

In order to clearly describe the technical scheme in the present disclosure, a brief description is given to accompanying figures used in following examples. Obviously, the accompanying figures described hereinafter are some examples in the present disclosure. An ordinary skilled in the art may obtain other figures with these accompanying figures without creative work.

FIG. 1 is a flow chart illustrating an information displaying method in accordance with an example of the present disclosure;

FIG. 2 is a flow chart illustrating another information displaying method in accordance with an example of the present disclosure;

FIG. 3 is a schematic diagram illustrating an application interface in accordance with an example of the present disclosure;

FIG. 4 is a schematic diagram illustrating another application interface in accordance with an example of the present disclosure;

FIG. 5 is a schematic diagram illustrating structure of a mobile terminal device in according with an example of the present disclosure;

FIG. 6 is a schematic diagram illustrating structure of another mobile terminal device in accordance with an example of the present disclosure; and

FIG. 7 is a schematic diagram illustrating structure of another mobile terminal device in accordance with an example of the present disclosure.

### DETAILED DESCRIPTION

Memory footprint may be stored in a folder of a mobile terminal device. If a user needs to obtain the memory footprint of the mobile terminal device, the user may search the folder for the memory footprint of the mobile terminal device.

The following problem may exist in the above technical scheme. The user may need to search for the memory footprint of the mobile terminal device in the folder. The user may find the folder after opening several applications in the searching process and obtain the memory footprint of the mobile terminal device. The user may be required to do a lot of operations and operation time may be long. Since the folder should be found, the searching process may be complicated and the searching efficiency may be low.

The present disclosure may be described in detail hereinafter with reference to the accompanying drawings to make the objective, technical solution and merits thereof more apparent.

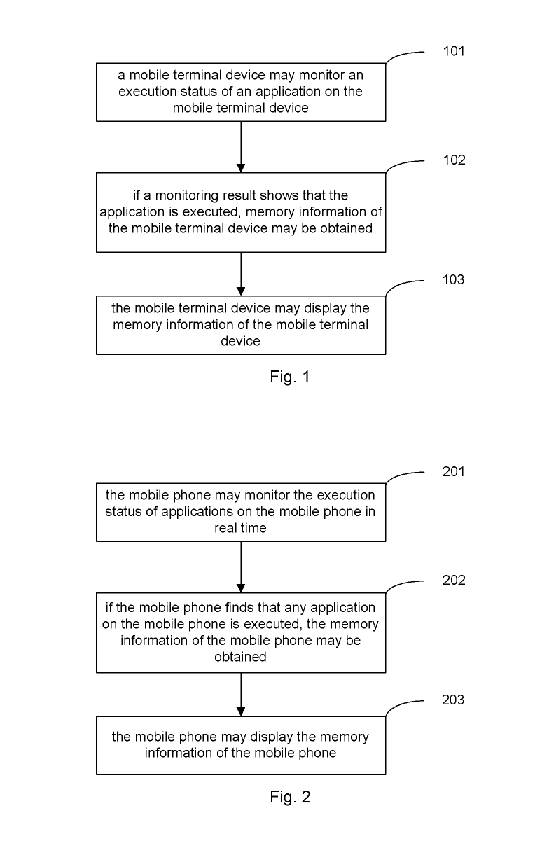

Referring to FIG. 1, an example of the present disclosure may provide an information displaying method. The method may include following blocks.

In block 101, a mobile terminal device may monitor an execution status of an application on the mobile terminal device.

According to an example of the present disclosure, the mobile terminal device may monitor the execution status of each application on the mobile terminal device in real time.

In block 102, if a monitoring result shows that the application is executed, memory information of the mobile terminal device may be obtained.

In block 103, the mobile terminal device may display the memory information of the mobile terminal device.

According to an example, the memory information of the mobile terminal device may include: memory information occupied by the executed application, or sum of the memory information occupied by the executed application and total occupied memory information of the mobile terminal device.

The method for obtaining the memory information of the mobile terminal device may include: calling thread information of the executed application by the mobile terminal device.

The memory information occupied by the executed application and stored in a first coding mode may be obtained according to the thread information of the executed application.

The memory information occupied by the executed application and stored in the first coding mode may be converted into information which may be displayed on the mobile terminal device.

The method for obtaining the total occupied memory information of the mobile terminal device may include:

calling the total occupied memory information of the mobile terminal device which may be stored in a second coding mode from a memory interface of the mobile terminal device; and

converting the total occupied memory information of the mobile terminal device which may be stored in the second coding mode into the information which may be displayed on the mobile terminal device.

According an example, the method for displaying the memory information of the mobile terminal device on the mobile terminal device may include: displaying the memory information of the mobile terminal device in a float window on the mobile terminal device.

The mobile terminal device in this example may be a mobile phone or a tablet PC.

In this example of the present disclosure, the mobile terminal device may monitor the execution status of an application. If the monitoring result shows that the application is executed, the memory information of the mobile terminal device may be obtained. The memory information of the mobile terminal device may be displayed on the mobile terminal device. Therefore, when the application is executed, the memory information of the mobile terminal device may be obtained and displayed. The user may not need to search for the memory information via opening multiple folders. The memory footprint of the mobile terminal device may be obtained by the user of the mobile terminal device, operation time may be reduced and the memory footprint searching efficiency may be enhanced.

An example of the present disclosure may provide an information displaying method. A mobile terminal device may monitor an execution status of applications on the mobile terminal device in real time. After the mobile terminal device execute any application, memory information occupied by the application may be displayed on a status bar of the application. Therefore, the mobile terminal device may timely obtain the memory footprint of the executed application. The mobile terminal device in this example may be the mobile phone or other handheld device. This example may be described hereinafter taking the mobile phone for example.

Referring to FIG. 2, the information displaying method provided by this example may include following blocks.

In block 201, the mobile phone may monitor the execution status of applications on the mobile phone in real time.

In this block, the execution status of the application may include an operation for executing an application by the mobile phone and an operation for executing function selection in the application by the mobile phone after the application is executed. If the mobile phone executes chatting software, the mobile phone may select a friend from a friend list and send a message to the friend after the mobile phone executes the chatting software. The mobile phone may monitor the above status.

The application may be any application installed on the mobile phone or a built-in application of the system of the mobile phone.

In block 202, if the mobile phone finds that any application on the mobile phone is executed, the memory information of the mobile phone may be obtained.

According to an example, source codes of an application on the mobile phone may be improved. The mobile phone may monitor the execute status of the applications on the mobile phone in real time. If the mobile phone executes an application on the mobile phone, the mobile phone may immediately obtain the execution status of the application to obtain the memory information of the mobile phone. The memory information of the mobile phone may include: memory information occupied by the executed application or the sum of the memory information occupied by the executed application and the total occupied memory information of the mobile phone. According to an example of the present disclosure, if the monitoring result shows that the application is executed, the memory information occupied by the application may be obtained. The mobile phone may further obtain the total occupied memory information of the mobile phone while obtaining the memory information occupied by the executed application. Therefore, the user may conveniently obtain the memory footprint of the mobile phone.

According to content of the memory information of the mobile phone, the method for obtaining the memory information of the mobile phone in this block may include: obtaining the memory information occupied by the currently-executed application and the total occupied memory information of the mobile phone. The method for obtaining the memory information occupied by the currently-executed application may include: calling the thread information of the currently-executed application by the mobile phone, obtaining the memory information occupied by the currently-executed application and stored in a first coding mode according to the thread information of the currently-executed application, converting the memory information occupied by the currently-executed application and stored in the first coding mode into information which may be displayed on the mobile phone and obtaining the memory information occupied by the currently-executed application. The memory information of the application may be recorded in a thread. The memory information may be recorded in the thread in the first coding mode. If the mobile phone directly displays the memory information stored in the first coding mode, the memory information may be garbled, which cannot be recognized by the user. Therefore, the memory information stored in the first coding mode should be converted into the information which may be displayed on the mobile phone.

In block 202, the method for obtaining the total occupied memory information of the mobile phone may include: calling the total occupied memory information of the mobile phone which may be stored in a second coding mode from a memory interface of the mobile phone, converting the total occupied memory information of the mobile phone which may be stored in the second coding mode into information which may be displayed on the mobile phone and obtaining the total occupied memory information of the mobile phone. In this example, the mobile phone may include a memory interface. The memory interface may record the occupied memory information of the mobile phone, which may be similar to that recorded in the thread. The memory information may be recorded by the interface in the second coding mode. If the mobile phone directly displays the memory information stored in the second coding mode, the memory information may be garbled, which cannot be recognized by the user. Therefore, the memory information stored in the second coding mode may be converted into the information which may be displayed on the mobile phone. The first coding mode and the second coding mode may be the same or may be different.

In block 203, the mobile phone may display the memory information of the mobile phone.

In this example, if the monitoring result shows that the application is executed, the memory information of the mobile phone may be obtained and the memory information may be displayed on a status bar of the mobile phone. The mobile phone may display the memory information on the status bar of the mobile phone in a float window or direct add a window to the status bar for displaying the memory information.

After the memory information is obtained, the value of the memory information may be returned to the status bar and displayed in the window of the status bar, or may be returned to the float window for displaying.

It should be noted that the float window or the window for displaying may be created when the application is opened. The memory information displayed in the float window or the window for displaying may be updated according to operation frequency of the application. When the currently-opened application is executed, an operation for obtaining the memory information of the mobile phone may be triggered.

According to an example, the memory information may be displayed on the status bar on the top of the mobile phone or on the status bar at the bottom of the mobile phone. The memory information may be displayed in the middle of the status bar or on the left or right of the status bar. If the memory information of the mobile phone includes the memory information occupied by the currently-executed application and the total occupied memory information of the mobile phone, the memory information occupied by the currently-executed application may be arranged before the total occupied memory information of the mobile phone or the total occupied memory information of the mobile phone may be arranged before the memory information occupied by the currently-executed application.

According to an example, the memory information of the mobile phone may include the total occupied memory information of the mobile phone. When the mobile phone obtains the memory information of the mobile phone, the total occupied memory information of the mobile phone may be obtained. The total occupied memory information of the mobile phone may be displayed on the status bar.

In order to better understand the methods provided by example of the present disclosure, an example may be described hereinafter.

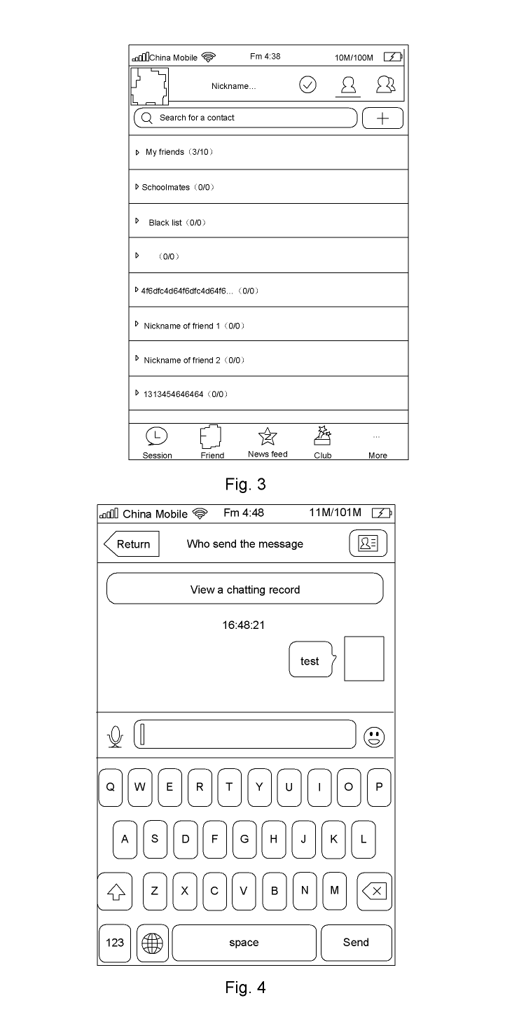

As shown in FIG. 3, the mobile phone may make the chatting software start. After the chatting software is started, the memory information occupied by the chatting software and the total occupied memory information of the mobile phone, i.e. 10M/100M may be displayed in the status bar of the interface. When a user selects a friend from a friend list and sends a message to the friend, the interface of the application may be transformed to that shown in FIG. 4. The currently-displayed memory information may be 11M/101M. The user may obtain the current memory footprint with the memory information displayed on the status bar. The user may not need to search for the memory footprint in a folder of the mobile terminal device. Therefore, it may be convenient for the user of the mobile terminal device to obtain the current memory footprint, the experiences of the user for using the mobile terminal device may be enhanced and it may be beneficial for the user of the mobile terminal device to manage the memory.

The mobile terminal device may monitor the exestuation status of an application. If the monitoring result shows that an application is executed, the memory information of the mobile terminal device may be obtained. The memory information of the mobile terminal device may be displayed on the mobile terminal device. Therefore, when the application is executed, the memory information of the mobile terminal device may be obtained and displayed. It may be avoided that user searches for the memory information via opening multiple folders. The memory footprint of the mobile terminal device may be obtained by the user of the mobile terminal device, operation time may be reduced and the memory footprint searching efficiency may be enhanced. Furthermore, according to an example, the occupied memory of the mobile phone may be displayed simultaneously. The user also may know the memory footprint of the mobile phone, which may be convenient for the management of the memory of the mobile phone. The memory information may be displayed in the float window, which may be conveniently implemented.

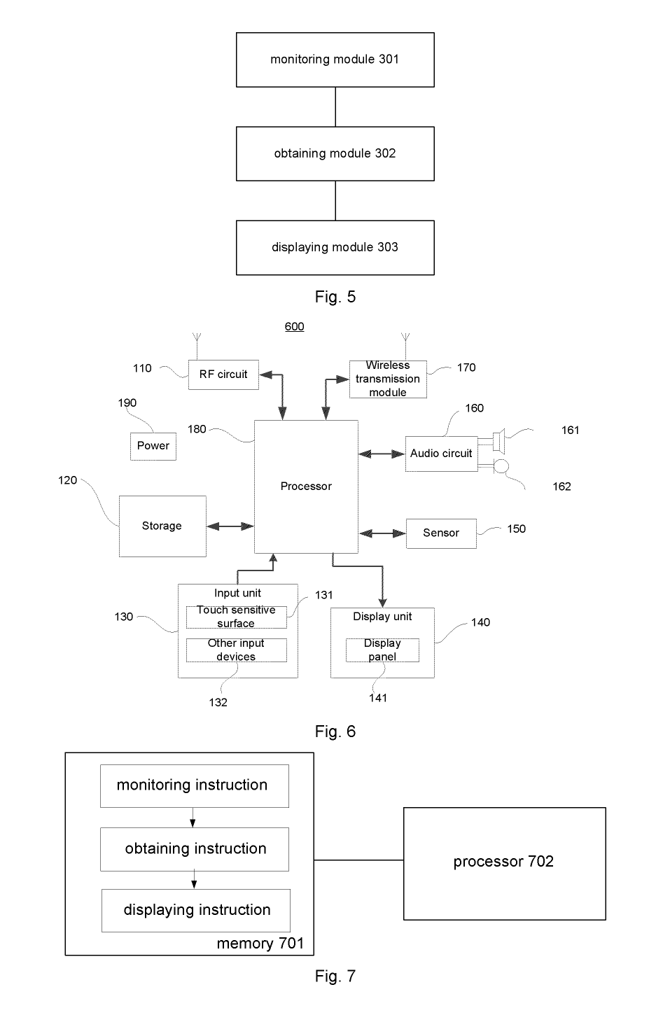

Referring to FIG. 5, an example of the present disclosure may provide a mobile terminal device. The mobile terminal device may include a monitoring module 301, an obtaining module 302 and a displaying module 303.

The monitoring module 301 may be to monitor an execution status of an application on the mobile terminal device.

According to an example of the present disclosure, the monitoring module 301 may be to monitor the execution status of the application on the mobile terminal device in real time.

The obtaining module 302 may be to obtain memory information of the mobile terminal device if a monitoring result shows that the application is executed.

The displaying module 303 may be to display the memory information of the mobile terminal device.

The memory information of the mobile terminal device may include: memory information occupied by the executed application, or sum of the memory information occupied by the executed application and total occupied memory information of the mobile terminal device.

The obtaining module 302 may include:

a calling unit, to call thread information of the currently-executed application;

a first obtaining unit, to obtain memory information occupied by the currently-executed application which is stored in a first coding mode according to the thread information of the currently-executed application; and

a first converting unit, to convert the memory information occupied by the currently-executed application which is stored in the first coding mode into information which may be displayed on the mobile terminal device.

The obtaining module 302 may further include:

a second obtaining unit, to call total occupied memory information of the mobile terminal device which may be stored in a second coding mode from a memory interface of the mobile terminal device; and

a second converting unit, to convert the total occupied memory information of the mobile terminal device which is stored in the second coding mode into information which may be displayed on the mobile terminal device.

The displaying module 303 may be further to display the memory information of the mobile terminal device in a float window.

The mobile terminal device in this example may be a mobile phone or a tablet PC.

The mobile terminal device may be the mobile phone. Based on the above modules in the mobile terminal device, the mobile terminal device may further include: a Radio Frequency (RF) circuit, an audio circuit and a power circuit.

The RF circuit may be to establish communication between the mobile phone and a wireless network and implement data receiving and sending between the mobile phone and the wireless network.

The audio circuit may be to collect voice and convert the collected voice into audio data, so that the mobile phone may send the audio data to the wireless network via the RF circuit. The audio circuit may be further to convert the audio data received form the wireless network via the RF circuit into the voice and play the voice to the user.

The power circuit may be to power each circuit or element of the mobile phone to ensure the mobile phone may normally work.

The mobile terminal device may be the mobile phone, a man-machine terminal device, an electronic book (e-book), or other mobile terminal devices with the display function. If the mobile terminal device is the mobile phone, the mobile phone may further include: a shell, a circuit board, a microphone and a loudspeaker to implement basic functions of the mobile phone. The shell, circuit board, microphone and loudspeaker may be described hereinafter.

The circuit board may be installed in the shell.

The microphone may be to collect voice and convert the collected voice into voice data, so that the mobile phone may send out the voice data to the wireless network via the RF circuit.

The louder speaker may be to convert the voice data received by the mobile phone from the wireless network via the RF circuit into the voice and play the voice for the user.

The mobile terminal device may monitor the execution status of the application on the mobile terminal device. When a monitoring result shows that the application is executed, the memory information of the mobile terminal device may be obtained. The mobile terminal device may display the memory information of the mobile terminal device. Therefore, when the application is executed, the memory information of the mobile terminal device may be obtained and displayed. The user needs not to search for the memory footprint in folders of the mobile terminal device. Therefore, it may be convenient for the user of the mobile terminal device to obtain the memory footprint, experiences of the user for using the mobile terminal device may be enhanced and it may be beneficial for the user of the mobile terminal device to manage the memory.

The mobile terminal device provided by examples of the present disclosure may have the same idea as that of the method examples. The implementation process of the mobile terminal devices may be shown in that of the method examples, which may not be repeated here.

It may be well known by an ordinary skilled in the art of the present disclosure that all or partial of blocks in the above examples may be implemented with hardware or implemented by a program instructing relevant hardware. The program may be stored in a non-transitory computer readable storage medium. The non-transitory computer readable storage medium may be a read only storage, a disk or a Compact Disc (CD), etc.

Referring to FIG. 6, FIG. 6 is a schematic diagram illustrating structure of another mobile terminal device in accordance with an example of the present disclosure. The mobile terminal device 600 may be used for implementing the above information displaying method in the above examples.

The mobile terminal device 600 may include a RF circuit 110, a storage 120 including one or more than one non-transitory computer readable storage medium, an input unit 130, a display unit 140, a sensor 150, an audio circuit 160, a wireless transmission module 170, a processor 180 including one or more than one processing core and a power 190, etc. It may be understood by an ordinary skilled in the art of the present disclosure that the structure of the mobile terminal device shown in FIG. 6 may not be used for limiting the mobile terminal device 600. The mobile terminal device may include more or fewer elements than those shown in the figure, may combine some elements, or may have different element arrangement.

The RF circuit 110 may be to perform information receiving and transmission or perform signal receiving and transmission during a call. The RF circuit 110 may receive downlink information from an eNB and send the downlink information to one or more than one processor 180 for processing. The RF circuit 110 may send uplink data to the eNB. The RF circuit 110 may include but may not be limited to an antenna, at least one amplifier, tuner, one or more oscillators, a Subscriber Identification Module (SIM) card, a transceiver, a coupler, a Low Noise Amplifier (LNA) and a duplexer, etc. The RF circuit 110 may communicate with a network or other devices in a wireless communication mode. The wireless communication may use any communication standard or protocol. The communication standard or protocol may include but not be limited to Global System of Mobile communication (GSM), General Packet Radio Service (GPRS), Code Division Multiple Access (CDMA), Wideband Code Division Multiple Access (WCDMA), Long Term Evolution (LTE), E-mail, and Short Messaging Service (SMS), etc.

The storage 120 may be to store programs and modules. The processor 180 may perform various function applications and data processing via running the programs and modules in the storage 120. The storage 120 may include a program storage area and a data storage area. The program storage area may store an Operating System (OS) and at least one application needed by a function (such as a voice playing function and image playing function), etc. The data storage area may store data created in the process of using the mobile terminal device (such as the audio data and a phone book). The storage 120 may be a high-speed random access memory. The storage 120 may include a non-transitory storage, such as at least one disk storage device, a flash memory, or other transitory solid storages. Accordingly, the storage 120 may further include a storage controller, so that the processor 180 and the input unit 130 may access the storage 120.

The input unit 130 may be to receive number or character information and generate keyboard signal input, mouse signal input, joystick signal input, optical or trackball signal input associated with users' setting and function control. The input unit 130 may include a touch sensitive surface 131 and other input devices 132. The touch sensitive surface 131 also may be called a touch screen or a touchpad and may collect touch operation of the user on or near the touch sensitive surface (for instance, operation performed by the user on or near the touch sensitive surface 131 with any suitable object such as a finger or a touch pen) and drive a corresponding connection device according to a preset program. The touch sensitive surface 131 may include a touch detection device and a touch controlling device. The touch detection device may detect a touch position of the user, detect a signal generated by the touch operation and send the signal to the touch controlling device. The touch controlling device may receive touch information from the touch detection device, convert the touch information into a touch coordinate, send the touch coordinate to the processor 180 and receive a command from the processor and execute the command. As for the example of the present disclosure, the memory information may be obtained and displayed by clicking a designated area. The touch sensitive surface 131 may be resistance touch sensitive surface, a capacitance touch sensitive surface, an infrared ray touch sensitive surface or a surface acoustic wave touch sensitive surface. Except of the touch sensitive surface 131, the input unit 130 may further include other input devices 132. The input device 132 may include but not be limited to at least one of a physical keyboard, a function key (such as a voice control button and a switch button), a trackball, a mouse, and a joystick. It should be noted that as FIG. 6 shows an example of the mobile terminal device with the touch sensitive surface 131. The mobile terminal device 600 may not be equipped with the touch sensitive surface 131.

The display unit 140 may display information input by the user, information provided to the user and various Graphic User Interfaces (GUI) s of the mobile terminal device 600. The GUIs may consist of an image, a text, an icon, a video or other random combination. The display unit 140 may include a display panel 141. The display panel 141 may be configured with a Liquid Crystal Display (LCD) and an Organic Light-Emitting Diode (OLED), etc. Furthermore, the touch sensitive surface 131 may cover the display panel 141. When the touch sensitive surface 131 detects an touch operation on or near the touch sensitive surface 131, the touch sensitive surface 131 may transmit the touch operation to the processor 180 to determine the type of a trigger event. Then, the processor 180 may provide a corresponding video output on the display panel 141 according to the type of the touch event.

The mobile terminal device 600 may further include at least one sensor 150, such as a light sensor, a motion sensor or other sensors. The light sensor may include an ambient light sensor and proximity sensor. The ambient light sensor may adjust the brightness of the display panel 141 according to the ambient light. The proximity sensor may close the display panel 141 and/or background light when the mobile terminal device 600 is near the ear. As one of the motion sensors, a gravity acceleration sensor may detect acceleration of each direction (generally be three axes), may detect the value and direction of the gravity in static, may be used in an application for identifying gesture of the mobile phone (such as horizontal screen-vertical screen switching, a related game and magnetometer calibration) and may be used for implementing a vibration identification related function (such as a pedometer and percussion). The mobile terminal device 600 may further be configured with other sensors, such as a gyroscope, barometer, hygrometer, a thermometer, and infrared sensor.

The audio circuit 160, a loudspeaker 161 or a microphone may provide an audio interface between the user and the mobile terminal device 600. The audio circuit 160 may send an electrical signal obtained by converting the audio data to the loudspeaker 161. The loudspeaker 161 may convert the electrical signal into a sound signal and output the sound signal. The microphone 162 may convert a collected sound signal into an electrical signal. The audio circuit 160 may receive the electrical signal and convert the electrical signal into the audio data and send the audio data to the processor 180 for processing. The audio data processed by the processor 180 may be sent to another terminal device via the RF circuit 110, or send the audio data to the storage 120 for further processing. The audio circuit 160 may further include a headset jack, so that a headphone may communicate with the mobile terminal device 600.

The wireless transmission module 170 may be a Wireless Fidelity (WiFi) module. The WiFi may belong to a short distance wireless transmission technology. The mobile terminal device 600 may help the user to send and receive an E-mail, browse a webpage and access streaming media, etc. via the wireless transmission module 170. The user may access the wireless broadband Internet with the wireless transmission module 170. Although the FIG. 6 includes the wireless transmission module 170, it may be understood that the mobile terminal derive may not include the wireless transmission module. The wireless transmission module 170 may be omitted without changing the protection scope of the present disclosure.

The processor 180 may be the control center of the mobile terminal device 600, may connect with element of the mobile phone with each interface and circuit, run or execute a program and/or module in the storage 120, call the data stored in the storage 120, execute various functions and processing data of the mobile terminal device 600, monitor and control the mobile phone. The processor may include one or multiple processing cores. An application processor and a modem processor may be integrated into the processor 180. The application processor may be used for processing the OS, a user interface and an application, etc. The modem processor may be used for processing wireless communication. The modem processor may not be integrated into the processor 180.

The mobile terminal device 600 may further include the power 190 (such as battery) powering each element. The power may logically connect with the processor 180 via a power management system. Functions such as, charging, discharging and power management may be implanted with the power management system. The power 190 may include one or more than one a Direct Current (DC) and an Alternating Current (AC) power, a rechargeable system, a power failure detection circuit, a power converter or inverter and a power status indicator.

The mobile terminal device may further include a camera, a Bluetooth module, etc. which may not be shown in the mobile terminal device 600. The display unit 140 of the mobile terminal device may be a touch screen monitor. The mobile terminal device 600 may further include a storage, one or more than one program. The one or more than one program may be stored in the storage. It may be configured that instructions in the one or more than one program for performing following processing may be executed by one or more than one processor. The execution status of the application may be monitored by the mobile terminal device in real time.

When the monitoring result shows that an application is executed, the current memory information of the mobile terminal device may be obtained and the current memory information of the mobile terminal device may be displayed.

The current memory information of the mobile terminal device may include: memory information occupied by the executed application, or sum of the memory information occupied by the executed application and total occupied memory information of the mobile terminal device.

The storage of the mobile terminal device may further include instructions for executing following operations:

callinig the thread information of the currently-executed application;

obtaining the memory information occupied by the currently-executed application and stored in a first coding mode according to the thread information of the currently-executed application;

converting the memory information occupied by the currently-executed application and stored in the first coding mode into information which may be displayed on the mobile terminal device.

The storage of the mobile terminal device may further include instructions for executing following operations:

calling the total occupied memory information of the mobile phone which may be stored in a second coding mode from a memory interface of the mobile phone;

converting the total occupied memory information of the mobile phone which may be stored in the second coding mode into information which may be displayed on the mobile terminal device.

The storage of the mobile terminal device may further include instructions for executing following operations:

displaying the memory information of the mobile terminal device in a float window.

An example of the present disclosure may further provide a non-transitory computer readable storage medium. The non-transitory computer readable storage medium may be independently set and may not be installed in a terminal device. The non-transitory computer readable storage medium may store one or more than one program. The one or more than one program may be executed by one or more than one processor to execute a slide control method. The method may include:

monitoring an execution status of an application on a mobile terminal device;

obtaining memory information of the mobile terminal device when a monitoring result shows that the application is executed; and

displaying the memory information of the mobile terminal device on the mobile terminal device.

The memory information of the mobile terminal device may include:

memory information occupied by the application; or

sum of the memory information occupied by the application and total occupied memory information of the mobile terminal device.

The method for obtaining the memory information of the mobile terminal device may include:

calling, by the mobile terminal device, thread information of the application;

obtaining the memory information of the application which is stored in a first coding mode according to the thread information of the application;

converting the memory information of the application which is stored in the first coding mode into information which may be displayed on the mobile terminal device.

The method for obtaining the memory information of the mobile terminal device may include:

calling the total occupied memory information of the mobile terminal device which is stored in a second coding mode from a memory interface of the mobile terminal device; and

converting the total occupied memory information of the mobile terminal device which is stored in the second coding mode into information which may be displayed on the mobile terminal device.

The method for displaying the memory information of the mobile terminal device on the mobile terminal device may include: displaying the memory information of the mobile terminal device in a float window on the mobile terminal device.

Referring to FIG. 7, FIG. 7 is a schematic diagram illsutraing structure of another mobile terminal device in accordance with an example of the present disclosure.

The mobile terminal device may include a memory 701 and a processor 702.

The memory 701 may store a monitoring instruction, an obtaining instruction and a displaying instruction.

The processor 702 may communicate with the memory 701, execute the above monitoring instruction, obtaining instruction and displaying instruction to respectively execute operations of the above monitoring module 301, obtaining module 302 and displaying module.

The obtaining instruction may include a calling sub-instruction, a first obtaining sub-instruction and a first conversion sub-instruction.

The processor 702 may be further to execute the calling sub-instruciton, the first obtaining sub-instruciton and first conversion sub-instruction to respectively execute operations of the above calling unit, first obtaining unit and first conversion unit.

The obtaining instruction may further include a second obtaining sub-instruction and a second conversion sub-instruction.

The processor 702 may further to execute the second obtaining sub-instruction and second conversion sub-instruction to respectively execute operations of the above second obtaining unit and second conversion unit.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An information displaying method, comprising:
monitoring an execution status of an application on a mobile terminal device;
obtaining memory information of the mobile terminal device when a monitoring result shows that the application is executed; and
displaying the memory information of the mobile terminal device on the mobile terminal device.

2. The method according to claim 1, wherein monitoring the execution status of the application on the mobile terminal device comprises:
monitoring, by the mobile terminal device, the execution status of the application on the mobile terminal device in real time.

3. The method according to claim 2, wherein the memory information of the mobile terminal device comprises:
memory information occupied by the application; or
sum of the memory information occupied by the application and total occupied memory information of the mobile terminal device.

4. The method according to claim 3, wherein obtaining the memory information of the mobile terminal device comprises:
calling, by the mobile terminal device, thread information of the application;
obtaining the memory information of the application which is stored in a first coding mode according to the thread information of the application;
converting the memory information of the application which is stored in the first coding mode into information which is displayed on the mobile terminal device.

5. The method according to claim 3, wherein obtaining the memory information of the mobile terminal device comprises:
calling the total occupied memory information of the mobile terminal device which is stored in a second coding mode from a memory interface of the mobile terminal device; and
converting the total occupied memory information of the mobile terminal device which is stored in the second coding mode into information which is displayed on the mobile terminal device.

6. The method according to claim 1, wherein displaying the memory information of the mobile terminal device on the mobile terminal device comprises:
displaying the memory information of the mobile terminal device in a float window on the mobile terminal device.

7. A mobile terminal device, comprising:
a memory, to store a monitoring instruction, an obtaining instruction and a displaying instruction; and
a processor, to
execute the monitoring instruction to monitor an execution status of an application on the mobile terminal device;
execute the obtaining instruction to obtain memory information of the mobile terminal device when a monitoring result shows that the application is executed; and
execute the displaying instruction to display the memory information of the mobile terminal device on the mobile terminal device.

8. The mobile terminal device according to claim 7, wherein
the processor is further to execute the monitoring instruction to monitor the execution status of the application on the mobile terminal device in real time.

9. The mobile terminal device according to claim 8, wherein the memory information of the mobile terminal device comprises:
memory information occupied by the application; or sum of the memory information occupied by the application and total occupied memory information of the mobile terminal device.

10. The mobile terminal device according to claim 9, wherein the obtaining instruction comprises: a calling sub-instruction, a first obtaining sub-instruction and a first conversion sub-instruction;
the processor is further to
execute the calling sub-instruction to call thread information of the application;
execute the first obtaining sub-instruction to obtain the memory information of the application which is stored in a first coding mode according to the thread information of the application; and
execute the first conversion sub-instruction to convert the memory information of the application which is stored in the first coding mode into information which is displayed on the mobile terminal device.

11. The mobile terminal device according to claim 9, wherein the obtaining instruction comprise: a second obtaining sub-instruction and a second conversion sub-instruction;
the processor is further to
execute the second obtaining sub-instruction to call the total occupied memory information of the mobile terminal device which is stored in a second coding mode from a memory interface of the mobile terminal device; and
execute the second conversion sub-instruction to convert the total occupied memory information of the mobile terminal device which is stored in the second coding mode into information which is displayed on the mobile terminal device.

12. The mobile terminal device according to claim 7, the processor is further to execute the displaying instruction to display the memory information of the mobile terminal device in a float window.

13. A non-transitory computer readable storage medium, comprising one or more than one program, to
monitor an execution status of an application on a mobile terminal device;
obtain memory information of the mobile terminal device when a monitoring result shows that the application is executed; and
display the memory information of the mobile terminal device on the mobile terminal device.

14. The non-transitory computer readable storage medium according to claim 13, wherein the program is further to:
monitor the execution status of the application on the mobile terminal device in real time.

15. The non-transitory computer readable storage medium according to claim 14, wherein the memory information of the mobile terminal device comprises:
memory information occupied by the application; or
sum of the memory information occupied by the application and total occupied memory information of the mobile terminal device.

16. The non-transitory computer readable storage medium according to claim 15, wherein the program is further to:
call thread information of the application;
obtain the memory information of the application which is stored in a first coding mode according to the thread information of the application;
convert the memory information of the application which is stored in the first coding mode into information which is displayed on the mobile terminal device.

17. The non-transitory computer readable storage medium according to claim 15, wherein the program is further to:
call the total occupied memory information of the mobile terminal device which is stored in a second coding mode from a memory interface of the mobile terminal device; and
convert the total occupied memory information of the mobile terminal device which is stored in the second coding mode into information which is displayed on the mobile terminal device.

18. The non-transitory computer readable storage medium according to claim 13, wherein the program is further to display the memory information of the mobile terminal device in a float window on the mobile terminal device.
